(19) United States
(12) Patent Application Publication
(10) Pub. No.: US 2026/0367822 A1
(43) Pub. Date: Nov. 19, 2026

(54) READ/WRITE SYSTEM OF RFID TAG AND READ/WRITE METHOD OF RFID TAG

(71) Applicant: YOKE INDUSTRIAL CORP., Taichung (TW)

(72) Inventor: RONG-DER HONG, Taichung City (TW)

(73) Assignee: YOKE INDUSTRIAL CORP., Taichung City (TW)

(21) Appl. No.: 19/257,466

(22) Filed: Jul. 2, 2025

(30) Foreign Application Priority Data
May 13, 2025 (TW) 114117918

(51) Int. Cl. G06F 3/06; G06F 16/955

(52) U.S. Cl. CPC G06F 3/0655; G06F 3/061; G06F 3/0679; G06F 16/955

(57) ABSTRACT

A read/write system of a RFID tag is provided with the RFID tag having a unique identifier code and a tag memory, wherein the tag memory has a memory state being one of a non-read-only state and a read-only state. The read/write system includes a read/write device including a read/write module and a controller electrically connected to the read/write module. The controller is configured to read the unique identifier code and the memory state through the read/write module and determines if the memory state is the non-read-only state. Based on the memory state being the non-read-only state, the controller outputs a link URL corresponding to the unique identifier code to the read/write module and writes the link URL into the tag memory through the read/write module. The link URL includes a base URL and the unique identifier code.

### BACKGROUND OF THE INVENTION

### Technical Field

The present invention relates generally to a read/write system, and more particularly to a read/write system of a RFID tag and a read/write method of a RFID tag.

### Description of Related Art

It is known that a product sold on the market is normally attached with a paper tag, wherein the paper tag records a basic information of the product by printing, such as name, specification, instructions for use. Therefore, through the paper tag, an administrator could easily manage the product or a user could refer to the paper tag for using the product.

However, because the paper tag might be damaged through the environmental factors during the user using the product or the product transported, the user or the administrator could not identify the basic information printed on the paper tag. In addition, to avoid affecting an appearance of the product or damaging a surface of the product, a size of the paper tag are normally constrained, so that the basic information of the product could not be completely recorded on the paper tag or the basic information of the product needs to be printed on an extra paper document. Therefore, the user could not easily use the product or the administrator could not easily manage the product, thereby reducing a convenience for the user and the administrator.

Therefore, how to raise a convenience through a read/write system is one of the technical issues in the art.

### BRIEF SUMMARY OF THE INVENTION

In view of the above, the primary objective of the present invention is to provide a read/write system of a RFID tag, which could read a unique identifier code of a RFID tag and write a link URL into the RFID tag corresponding to the unique identifier code.

The present invention provides a read/write system of a RFID tag, wherein the RFID tag has a unique identifier code and a tag memory. The tag memory has a memory state, wherein the memory state is one of a non-read-only state and a read-only state. The read/write system includes a read/write device, wherein the read/write device includes a read/write module and a controller. The controller is electrically connected to the read/write module. The controller is configured to read the unique identifier code and the memory state of the RFID tag through the read/write module and determines if the memory state is the non-read-only state. Based on the memory state being the non-read-only state, the controller outputs a link URL corresponding to the unique identifier code to the read/write module and writes the link URL into the tag memory of the RFID tag through the read/write module, wherein the link URL includes a base URL and the unique identifier code.

The present invention further provides a read/write method of the RFID tag, wherein the RFID tag has the unique identifier code and the tag memory. The tag memory has the memory state, wherein the memory state is one of the non-read-only state and the read-only state. The read/write method utilizes the read/write system, wherein the read/write system includes the read/write device. The read/write device includes the read/write module and the controller, wherein the controller is electrically connected to the read/write module. The read/write method includes the following steps:
step A: the controller of the read/write device reads the unique identifier code and the memory state of the RFID tag through the read/write module;
step B: the controller of the read/write device determines if the memory state is the non-read-only state;
step C: the controller of the read/write device outputs a link URL corresponding to the unique identifier code to the read/write module based on the memory state being the non-read-only state and writes the link URL into the tag memory of the RFID tag through the read/write module, wherein the link URL includes the base URL and the unique identifier code.

With the aforementioned design, through the read/write module reading the unique identifier code of the RFID tag and the controller writing the link URL corresponding to the unique identifier code into the tag memory of the RFID tag through the read/write module, the RFID tag could be a medium to obtain the link URL for obtaining a related information of a product through the link URL. Therefore, a purpose of raising a convenience of the read/write system could be achieved.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a schematic view of the read/write system of the RFID tag according to a first embodiment of the present invention;

FIG. 2 is a flow chart of the read/write method of the RFID tag according to the first embodiment of the present invention;

FIG. 3 is a flow chart of the read/write method of the RFID tag according to the first embodiment of the present invention;

FIG. 4 is a schematic view of the digital product passport website according to the first embodiment of the present invention;

FIG. 5 is a schematic view of the read/write system of the RFID tag according to a second embodiment of the present invention;

FIG. 6 is a schematic view of the read/write system of the RFID tag, showing that that controller blocks an electrical connection between that controller and the processing device according to the second embodiment of the present invention;

FIG. 7 is a flow chart of the read/write method of the RFID tag according to the second embodiment of the present invention;

FIG. 8 is a flow chart of the read/write method of the RFID tag according to the second embodiment of the present invention;

FIG. 9 is a flow chart of the read/write method of the RFID tag according to a third embodiment of the present invention; and

FIG. 10 is a flow chart of the read/write method of the RFID tag according to the third embodiment of the present invention.

### DETAILED DESCRIPTION OF THE INVENTION

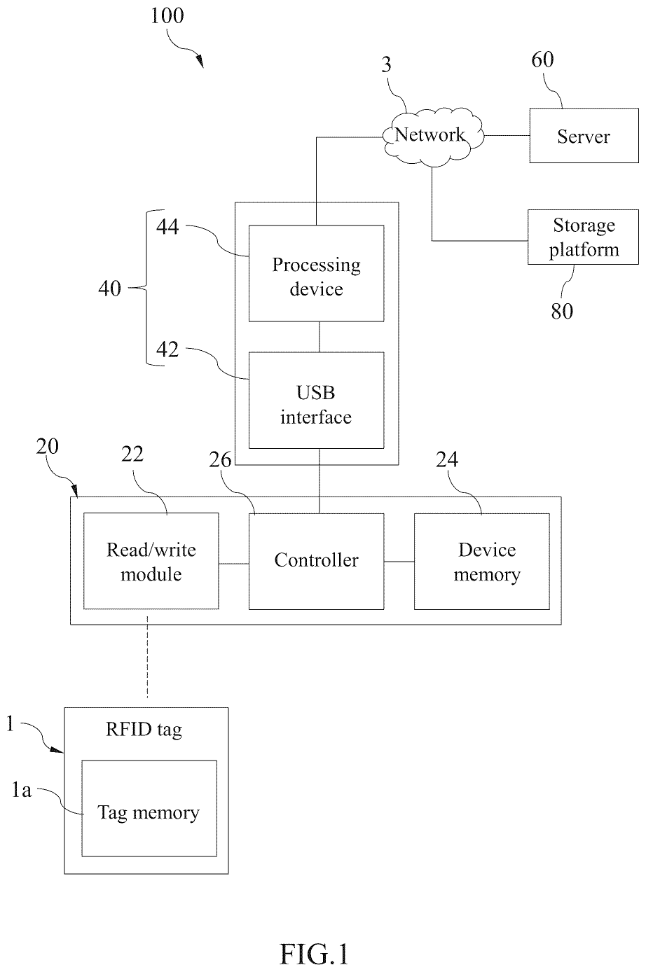

A read/write system 100 of a RFID tag 1 according to a first embodiment of the present invention is illustrated in FIG. 1, wherein the RFID tag 1 has a unique identifier code (UID) and a tag memory 1a. The tag memory 1a has a memory state, wherein the memory state is one of a non-read-only state and a read-only state. The read/write system 100 includes a read/write device 20, an electronic device 40, a server 60, and a storage platform 80.

The read/write device 20 includes a read/write module 22, a device memory 24, and a controller 26, wherein the read/write module 22 is adapted to read data and write data into the tag memory 1a of the RFID tag 1. The controller 26 is electrically connected to the read/write module 22 and the device memory 24.

The electronic device 40 includes a USB (Universal Serial Bus) interface 42 and a processing device 44, wherein the processing device 44 is electrically connected to the USB interface 42 and is electrically connected to the controller 26 through the USB interface 42. The processing device 44, the server 60, and the storage platform 80 are signally connected to one another through a network 3. In the current embodiment, the controller 26 is connected to the USB interface 42 through a signal cable; the electronic device 40 could be a personal computer or a laptop as an example, but not limited thereto.

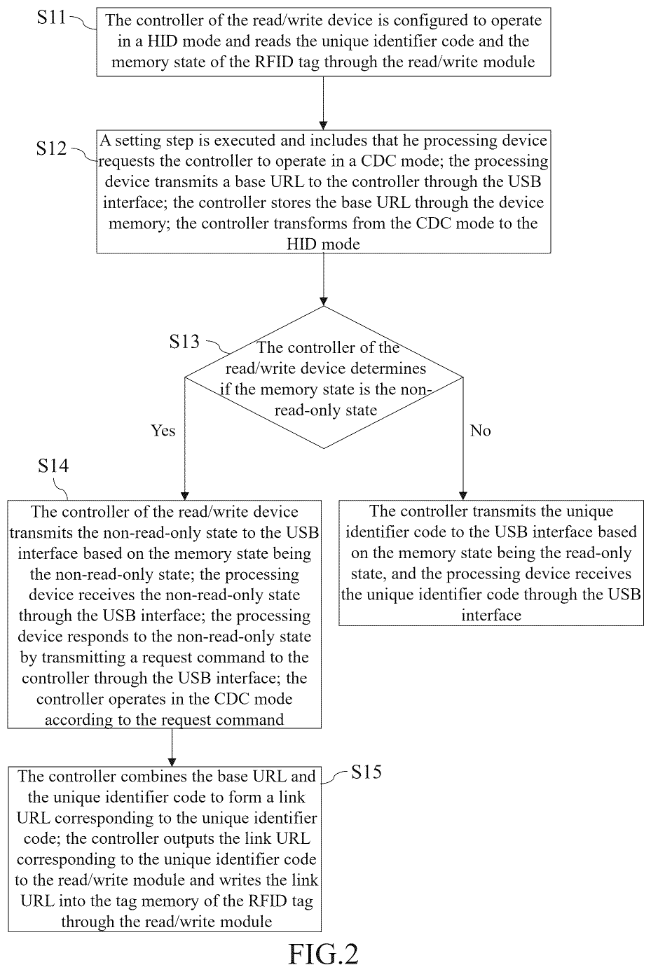

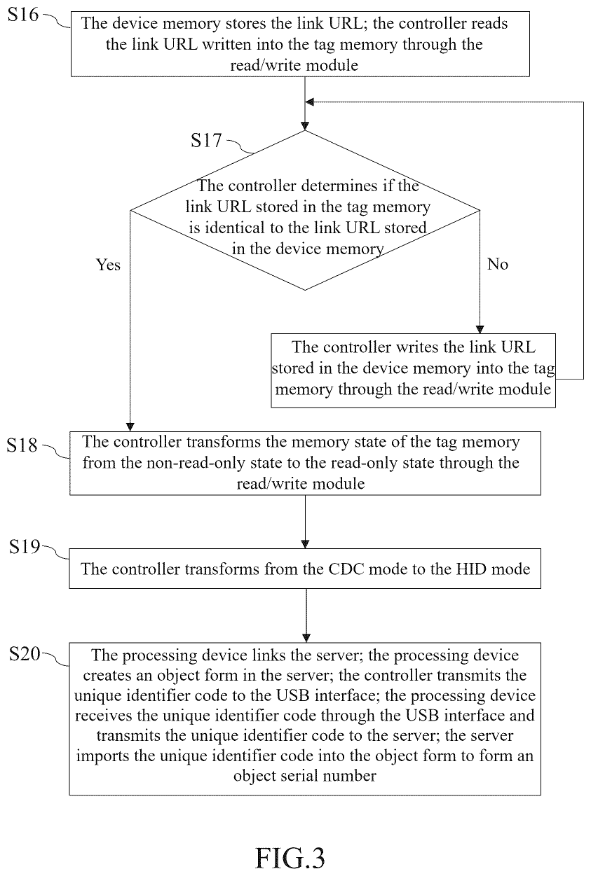

Through the aforementioned configuration of the read/write system 100, a read/write method of the RFID tag 1 according to the first embodiment of the present invention could be executed. Referring to FIG. 2 and FIG. 3, the read/write method includes the following steps:
Step S11: the controller 26 of the read/write device 20 is configured to operate in a HID (Human Interface Device) mode and reads the unique identifier code and the memory state of the RFID tag 1 through the read/write module 22.
Step S12: a setting step is executed and includes the following step:

The processing device 44 requests the controller 26 to operate in a CDC (Communications Device Class) mode; the processing device 44 transmits a base URL to the controller 26 through the USB interface 42; the controller 26 stores the base URL through the device memory 24. In the current embodiment, the base URL is adapted to link the storage platform 80.

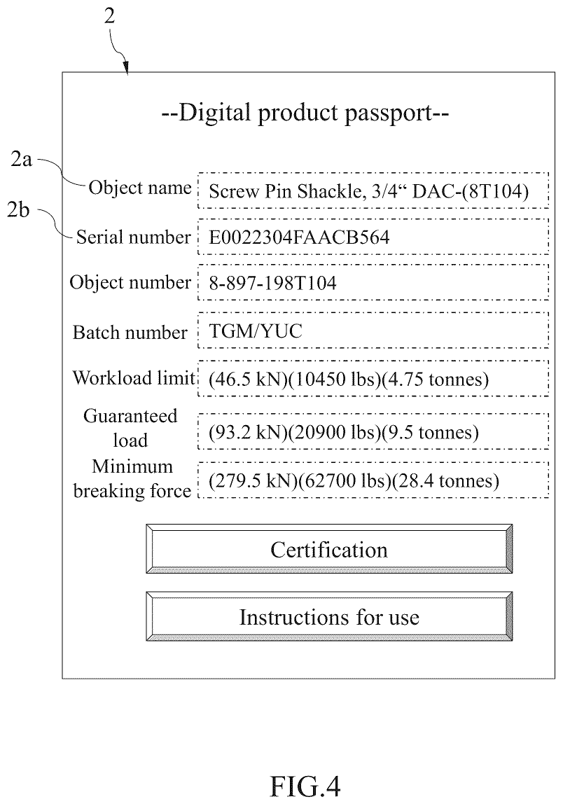

After the device memory 24 stores the base URL, the controller 26 transforms from the CDC mode to the HID mode. In other embodiments, that the processing device 44 requests the controller 26 to operate in the CDC mode could be omitted upon the required demand, i.e., in the setting step, the controller 26 keeps operating in the HID mode.
Step S13: the controller 26 of the read/write device 20 determines if the memory state is the non-read-only state; when the memory state is the non-read-only state, step S14 would be executed; when the memory state is not the non-read-only state, the controller 26 transmits the unique identifier code to the USB interface 42 based on the memory state being the read-only state, and the processing device 44 receives the unique identifier code through the USB interface 42. In the current embodiment, step S20 could be directly executed upon the required demand after the processing device 44 receives the unique identifier code through the USB interface 42.
Step S14: the controller 26 of the read/write device 20 transmits the non-read-only state to the USB interface 42 based on the memory state being the non-read-only state; the processing device 44 receives the non-read-only state through the USB interface 42; the processing device 44 responds to the non-read-only state by transmitting a request command to the controller 26 through the USB interface 42; the controller 26 operates in the CDC mode according to the request command. In other embodiments, the controller 26 could independently transform from the HID mode to the CDC mode based on the memory state being the non-read-only state upon the required demand.
Step S15: the controller 26 combines the base URL and the unique identifier code to form a link URL corresponding to the unique identifier code; the controller 26 outputs the link URL corresponding to the unique identifier code to the read/write module 22 and writes the link URL into the tag memory 1a of the RFID tag 1 through the read/write module 22. In the current embodiment, the link URL is adapted to link a digital product passport website 2 (as shown in FIG. 4) for an electronic device which could be connected to the network 3 through the network 3. For example, when the base URL is “https://dpp...com/storagespace/”and the unique identifier code is “E0022304FAACB56”, the link URL is “https://dpp...com/storagespace/E0022304FAACB564”.
Step S16: the device memory 24 stores the link URL; the controller 26 reads the link URL written into the tag memory 1a through the read/write module 22.
Step S17: the controller 26 determines if the link URL stored in the tag memory 1a is identical to the link URL stored in the device memory 24; when the link URL stored in the tag memory 1a is identical to the link URL stored in the device memory 24, step S18 would be executed; when the link URL stored in the tag memory 1a is not identical to the link URL stored in the device memory 24, the controller 26 writes the link URL stored in the device memory 24 into the tag memory 1a through the read/write module 22, and step S17 would be executed again.
Step S18: the controller 26 transforms the memory state of the tag memory 1a from the non-read-only state to the read-only state through the read/write module 22.

In the current embodiment, step S18 is executed, but not limited to, after step S16 and step S17. Step S16 and step S17 could be omitted and step S18 could be executed after step S15.
Step S19: the controller 26 transforms from the CDC mode to the HID mode. In the current embodiment, the controller 26 could independently operate in the HID mode upon the required demand; alternatively, the controller 26 could correspondingly inform the processing device 44 and the processing device 44 requests the controller 26 to operate in the HID mode through the USB interface 42.

In the current embodiment, step S19 is executed, but not limited to, after step S18. Step S18 could be omitted and step S19 could be executed after step S17. In addition, step S16, step S17, and step S18 could be omitted and step S19 could be executed after step S15.
Step S20: the processing device 44 links the server 60; the processing device 44 creates an object form in the server 60; the controller 26 transmits the unique identifier code to the USB interface 42; the processing device 44 receives the unique identifier code through the USB interface 42 and transmits the unique identifier code to the server 60; the server 60 imports the unique identifier code into the object form to form an object serial number 2b.

In the current embodiment, the server 60 transmits the object form to the storage platform 80 to form an object information 2a; the digital product passport website 2 links the object information 2a; besides the object serial number 2b, the object information 2a could include an object name, an object number, a batch number as an example, but not limited thereto. Therefore, the electronic device which could be connected to the network 3 could click the link URL through a web browser to link the digital product passport website 2 stored in the storage platform 80, so that the object information 2a of the digital product passport website 2 could be browsed.

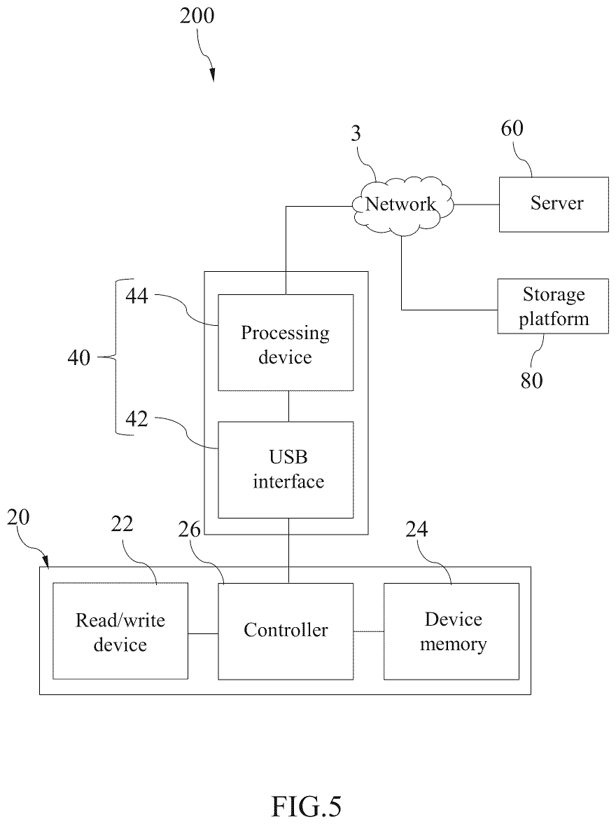

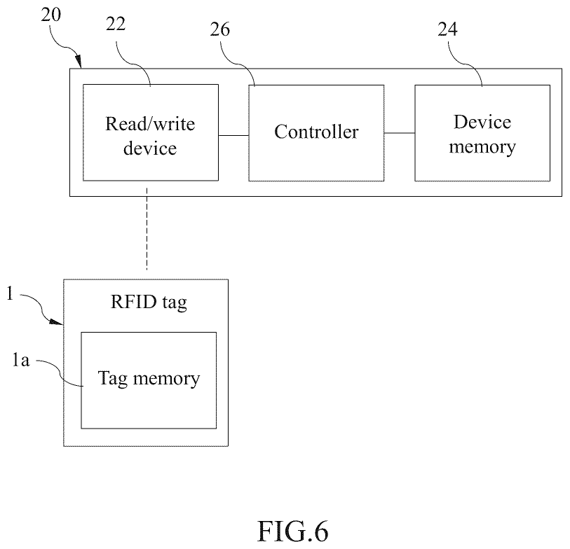

A read/write system 200 of the RFID tag 1 according to a second embodiment of the present invention is illustrated in FIG. 5 and FIG. 6. A structure of the read/write system 200 is almost identical to a structure of the read/write system 100, except that the read/write device 20 is separably connected to the electronic device 40.

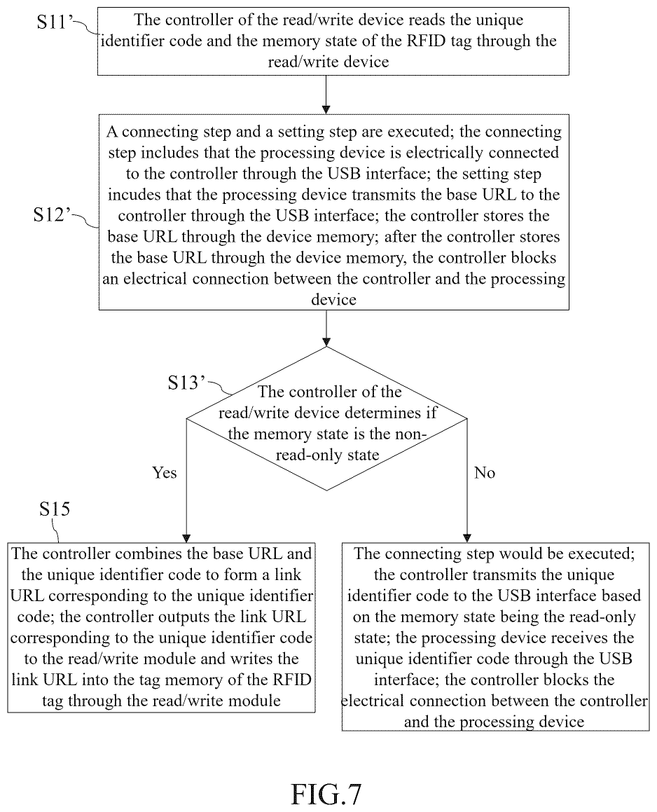

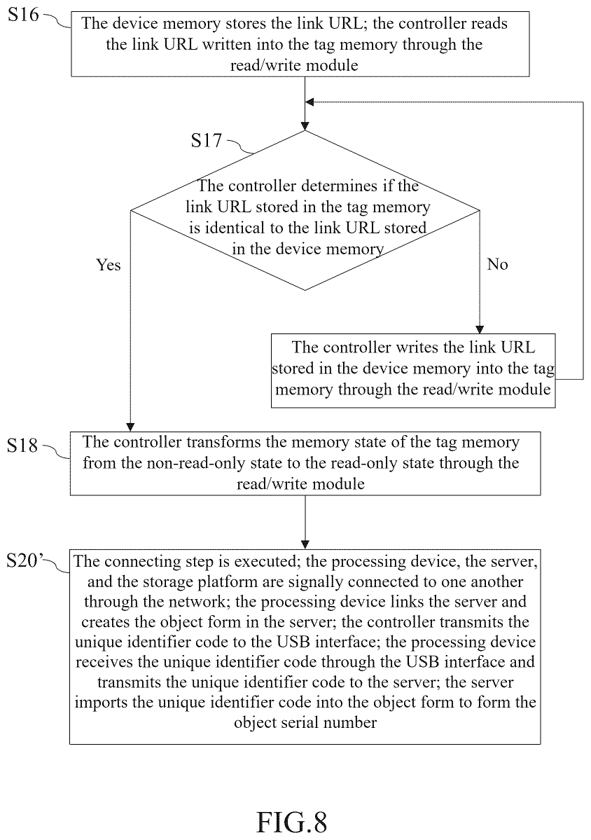

Through the aforementioned configuration of the read/write system 200, a read/write method of the RFID tag 1 according to the second embodiment of the present invention could be executed. Referring to FIG. 7 and FIG. 8, a structure of the read/write method of the RFID tag 1 of the second embodiment is almost identical to a structure of the read/write method of the RFID tag 1 of the first embodiment, except that step S14 and step S19 are omitted and the read/write method of the second embodiment includes the following steps:
Step S11′: the controller 26 of the read/write device 20 reads the unique identifier code and the memory state of the RFID tag 1 through the read/write device 20.
Step S12′: a connecting step and a setting step are executed.

The connecting step includes that the processing device 44 is electrically connected to the controller 26 through the USB interface 42. In the current embodiment, the controller 26 could be connected to the USB interface 42 through the signal cable; the electronic device 40 could be a personal computer or a laptop, but not limited thereto.

The setting step incudes that the processing device 44 transmits the base URL to the controller 26 through the USB interface 42; the controller 26 stores the base URL through the device memory 24; after the controller 26 stores the base URL through the device memory 24, the controller 26 blocks an electrical connection between the controller 26 and the processing device 44. In the current embodiment, in the setting step, the processing device 44 requests the controller 26 to operate in the CDC mode, but not limited thereto.
Step S13′: the controller 26 of the read/write device 20 determines if the memory state is the non-read-only state; when the memory state is the non-read-only state, step S15 would be executed to write the link URL into the tag memory 1a through the read/write module 22. Therefore, the read/write device 20 could independently operate and does not need to be connected to the electronic device 40.

When the memory state is not the non-read-only state, the connecting step would be executed; the controller 26 transmits the unique identifier code to the USB interface 42 based on the memory state being the read-only state; the processing device 44 receives the unique identifier code through the USB interface 42; the controller 26 blocks the electrical connection between the controller 26 and the processing device 44. In the current embodiment, step S20′ could be executed upon the required demand after the controller 26 blocks the electrical connection between the controller 26 and the processing device 44.
Step S20′: the connecting step is executed; the processing device 44, the server 60, and the storage platform 80 are signally connected to one another through the network 3; the processing device 44 links the server 60 and creates the object form in the server 60; the controller 26 transmits the unique identifier code to the USB interface 42; the processing device 44 receives the unique identifier code through the USB interface 42 and transmits the unique identifier code to the server 60; the server 60 imports the unique identifier code into the object form to form the object serial number 2b.

In another embodiment, the read/write device 20 could be connected to the electronic device 40 through wireless connection based on the memory state being the read-only state, e.g., bluetooth. Therefore, the connecting step could be omitted in step S13′ and step S20′, and the controller 26 could transmit the unique identifier code to the processing device 44 to import the unique identifier code into the object form.

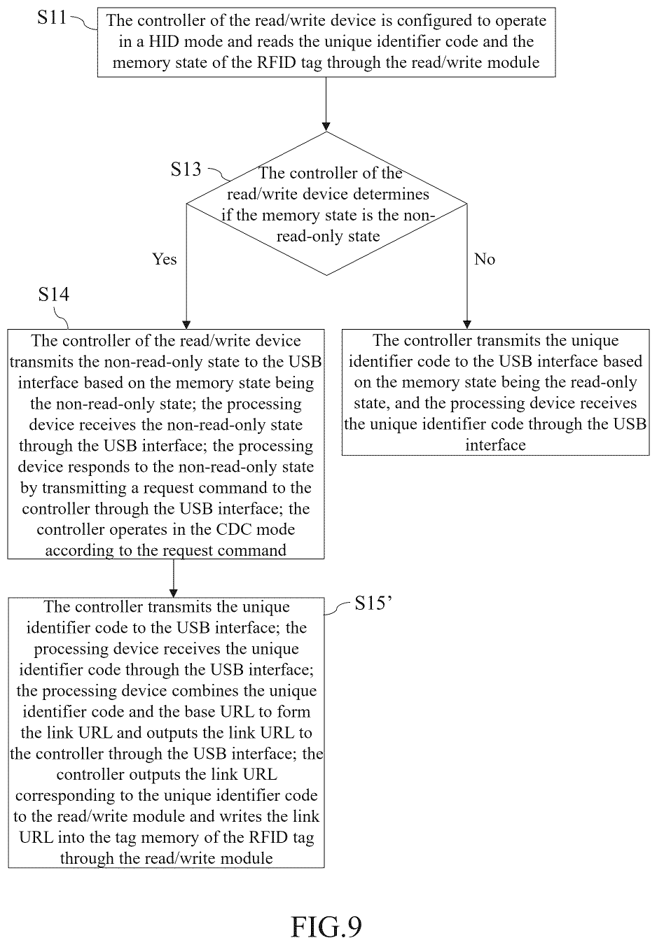

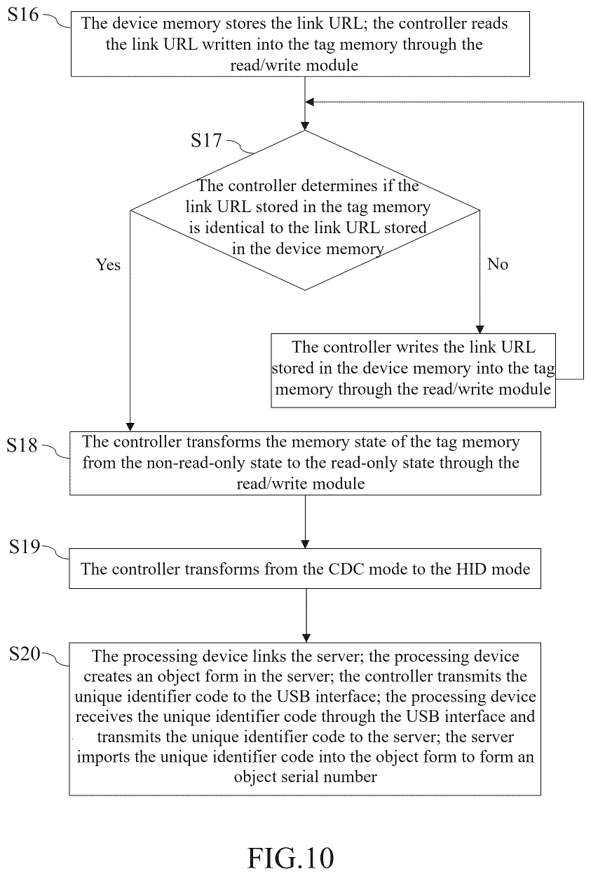

A read/write method of the RFID tag 1 according to a third embodiment of the present invention is illustrated in FIG. 9 and FIG. 10. A structure of the read/write method of the third embodiment is almost identical to the structure of the read/write method of the first embodiment, except that step S12 is omitted and the read/write method of the third embodiment includes the following steps:
Step S15′: the controller 26 transmits the unique identifier code to the USB interface 42; the processing device 44 receives the unique identifier code through the USB interface 42; the processing device 44 combines the unique identifier code and the base URL to form the link URL and outputs the link URL to the controller 26 through the USB interface 42; the controller 26 outputs the link URL corresponding to the unique identifier code to the read/write module 22 and writes the link URL into the tag memory 1a of the RFID tag 1 through the read/write module 22.

With the aforementioned design, through the read/write module 22 reading the unique identifier code of the RFID tag 1 and the controller 26 writing the link URL corresponding to the unique identifier code into the tag memory 1a of the RFID tag 1 through the read/write module 22, the RFID tag 1 could be a medium to obtain the link URL to link the digital product passport website 2 through the link URL, so that the object information 2a could be obtained. In addition, the controller 26 could determine if the link URL stored in the tag memory 1a is identical to the link URL stored in the device memory 24. When the link URL stored in the tag memory 1a is not identical to the link URL stored in the device memory 24, the link URL could be written into the tag memory 1a through the read/write module 22, thereby ensuring that an accuracy of the link URL stored in the tag memory 1a. Therefore, a negligence of a management and an inconvenience of a user could be avoided to raise a convenience for an administrator and the user.

It must be pointed out that the embodiments described above are only some preferred embodiments of the present invention. All equivalent structures which employ the concepts disclosed in this specification and the appended claims should fall within the scope of the present invention.

What is claimed is:

1. A read/write system of a RFID tag, wherein the RFID tag has a unique identifier code and a tag memory; the tag memory has a memory state, wherein the memory state is one of a non-read-only state and a read-only state; the read/write system comprises:
a read/write device comprising a read/write module and a controller, wherein the controller is electrically connected to the read/write module; the controller is configured to read the unique identifier code and the memory state of the RFID tag through the read/write module and determine if the memory state is the non-read-only state; based on the memory state being the non-read-only state, the controller outputs a link URL corresponding to the unique identifier code to the read/write module and writes the link URL into the tag memory of the RFID tag through the read/write module, wherein the link URL comprises a base URL and the unique identifier code.

2. The read/write system of the RFID tag as claimed in claim 1, wherein the controller is configured to operate in a HID (Human Interface Device) mode and reads the unique identifier code and the memory state of the RFID tag through the read/write module.

3. The read/write system of the RFID tag as claimed in claim 2, further comprising an electronic device, wherein the electronic device comprises a USB (Universal Serial Bus) interface and a processing device; the processing device is electrically connected to the USB interface; the processing device is electrically connected to the controller through the USB interface; the controller transmits the non-read-only state to the USB interface based on the memory state being the non-read-only state; the processing device receives the non-read-only state through the USB interface and responds to the non-read-only state by transmitting a request command to the controller through the USB interface; the controller operates in a CDC (Communications Device Class) mode according to the request command and writes the link URL into the tag memory of the RFID tag through the read/write module.

4. The read/write system of the RFID tag as claimed in claim 3, wherein the controller transforms from the CDC mode to the HID mode after the controller writes the link URL into the tag memory through the read/write module.

5. The read/write system of the RFID tag as claimed in claim 3, wherein the controller transmits the unique identifier code to the USB interface; the processing device receives the unique identifier code through the USB interface; the processing device combines the unique identifier code and the base URL to form the link URL and outputs the link URL to the controller through the USB interface.

6. The read/write system of the RFID tag as claimed in claim 1, further comprising an electronic device and a server, wherein the electronic device comprises a USB interface and a processing device; the processing device is electrically connected to the USB interface; the processing device is electrically connected to the controller through the USB interface; the controller transmits the unique identifier code to the USB interface based on the memory state being the read-only state; the processing device receives the unique identifier code through the USB interface; the processing device links the server; the processing device creates an object form in the server; the controller transmits the unique identifier code to the USB interface; the processing device receives the unique identifier code through the USB interface and transmits the unique identifier code to the server; the server imports the unique identifier code into the object form to form an object serial number.

7. The read/write system of the RFID tag as claimed in claim 1, further comprising an electronic device and a server, wherein the electronic device comprises a USB interface and a processing device; the processing device is electrically connected to the USB interface; the processing device is electrically connected to the controller through the USB interface; the read/write device comprises a device memory, wherein the device memory is electrically connected to the controller; the processing device transmits the base URL to the controller through the USB interface; the controller stores the base URL through the device memory; the controller combines the unique identifier code and the base URL to form the link URL corresponding to the unique identifier code.

8. The read/write system of the RFID tag as claimed in claim 1, wherein the controller transforms the memory state from the non-read-only state to the read-only state through the read/write module after the controller writes the link URL into the tag memory through the read/write module.

9. The read/write system of the RFID tag as claimed in claim 1, wherein the read/write device comprises a device memory; the device memory is electrically connected to the controller; the controller stores the link URL through the device memory; the controller reads the link URL written into the tag memory through the read/write module; the controller obtains the link URL from the device memory corresponding to the unique identifier code; when the controller determines that the link URL stored in the tag memory is not identical to the link URL stored in the device memory, the controller writes the link URL stored in the device memory into the tag memory through the read/write module.

10. A read/write method of a RFID tag, wherein the RFID tag has a unique identifier code and a tag memory; the tag memory has a memory state, wherein the memory state is one of a non-read-only state and a read-only state; the read/write method utilizes a read/write system, wherein the read/write system comprises a read/write device; the read/write device comprises a read/write module and a controller, wherein the controller is electrically connected to the read/write module; the read/write method comprises the following steps:
step A: the controller of the read/write device reads the unique identifier code and the memory state of the RFID tag through the read/write module;
step B: the controller of the read/write device determines if the memory state is the non-read-only state;
step C: the controller of the read/write device outputs a link URL corresponding to the unique identifier code to the read/write module based on the memory state being the non-read-only state and writes the link URL into the tag memory of the RFID tag through the read/write module, wherein the link URL comprises a base URL and the unique identifier code.

11. The read/write method of the RFID tag as claimed in claim 10, wherein in step C, the controller combines the base URL and the unique identifier code to form the link URL corresponding to the unique identifier code.

12. The read/write method of the RFID tag as claimed in claim 11, wherein the read/write system comprises an electronic device; the electronic device comprises a USB interface and a processing device, wherein the processing device is electrically connected to the USB interface; the processing device is electrically connected to the controller through the USB interface; the read/write device comprises a device memory, wherein the device memory is electrically connected to the controller; a setting step is executed after step A, wherein the setting step comprises the following steps:
the processing device requests the controller to operate in a CDC mode; the processing device transmits the base URL to the controller through the USB interface; the controller stores the base URL through the device memory; after the device memory stores the base URL, the controller transforms from the CDC mode to a HID mode.

13. The read/write method of the RFID tag as claimed in claim 11, wherein the read/write system comprises an electronic device; the electronic device comprises a USB interface and a processing device, wherein the processing device is electrically connected to the USB interface; the processing device is electrically connected to the controller through the USB interface; the read/write method of the RFID tag further comprises the following steps after step A:
a setting step is executed and comprises:
the read/write device comprises a device memory, wherein the device memory is electrically connected to the controller; the processing device transmits the base URL to the controller through the USB interface; the controller stores the base URL through the device memory; after the device memory stores the base URL, the controller blocks an electrical connection between the controller and the processing device.

14. The read/write method of the RFID tag as claimed in claim 10, wherein in step A, the controller is configured to operate in a HID mode; in step C, the controller is configured to operate in a CDC mode.

15. The read/write method of the RFID tag as claimed in claim 14, wherein the read/write system comprises an electronic device; the electronic device comprises a USB interface and a processing device, wherein the processing device is electrically connected to the USB interface; the processing device is electrically connected to the controller through the USB interface; in step C, the controller transmits the non-read-only state to the USB interface based on the memory state being the non-read-only state; the processing device receives the non-read-only state through the USB interface; the processing device responds to the non-read-only state by transmitting a request command to the controller through the USB interface; the controller operates in the CDC mode according to the request command.

16. The read/write method of the RFID tag as claimed in claim 15, wherein in step C, the controller transmits the unique identifier code to the USB interface; the processing device receives the unique identifier code through the USB interface; the processing device combines the unique identifier code and the base URL to form the link URL and outputs the link URL to the controller through the USB interface.

17. The read/write method of the RFID tag as claimed in claim 14, further comprising the following step after step C: the controller transforms from the CDC mode to the HID mode.

18. The read/write method of the RFID tag as claimed in claim 10, further comprising the following step after step C:
step D: the controller transforms the memory state of the RFID tag from the non-read-only state to the read-only state through the read/write module.

19. The read/write method of the RFID tag as claimed in claim 10, wherein the read/write device comprises a device memory; the device memory is electrically connected to the controller; the read/write method of the RFID tag further comprises the following steps after step C:
step D01: the device memory stores the link URL; the controller reads the link URL written into the tag memory through the read/write module;
step D02: when the controller determines that the link URL stored in the tag memory is identical to the link URL stored in the device memory, the controller transforms the memory state of the RFID tag from the non-read-only state to the read-only state through the read/write module;
when the controller determines that the link URL stored in the tag memory is not identical to the link URL stored in the device memory, the controller writes the ink URL stored in the device memory into the tag memory and step D02 is executed again.

20. The read/write method of the RFID tag as claimed in claim 10, wherein the read/write system comprises an electronic device and a server; the electronic device comprises a USB interface and a processing device, wherein the processing device is electrically connected to the USB interface; the processing device is electrically connected to the controller through the USB interface; in step C, the controller transmits the unique identifier code to the USB interface based on the memory state being the read-only state, and the processing device receives the unique identifier code through the USB interface; the read/write method of the RFID tag further comprises the following steps after step C: the processing device links the server and creates an object form in the server; the controller transmits the unique identifier code to the USB interface; the processing device receives the unique identifier code through the USB interface and transmits the unique identifier code to the server; the server imports the unique identifier code into the object form to form an object serial number.
